(19) United States
(12) Patent Application Publication
(10) Pub. No.: US 2021/0073754 A1
(43) Pub. Date: Mar. 11, 2021

(54) METHOD AND SYSTEM TO EXECUTE AND RECORD TRANSACTIONS FOR A KEY-BOX IN A BLOCKCHAIN

(71) Applicant: Carrier Corporation, Palm Beach Gardens, FL (US)

(72) Inventors: Ramesh LINGALA, Hyderabad (IN); Gowthami Vuradi, Hyderabad (IN)

(21) Appl. No.: 17/014,297

(22) Filed: Sep. 8, 2020

(30) Foreign Application Priority Data
Sep. 10, 2019 (IN) 201911036398

(51) Int. Cl. G06Q 20/06; G06Q 20/36; G06Q 20/38

(52) U.S. Cl. CPC G06Q 20/065; G06Q 2220/00; G06Q 20/382; G06Q 20/367

(57) ABSTRACT

A system and method for executing and recording transactions in a blockchain. A method includes creating a smart contract on receiving a request to order a key-box on lease for a first period of time. The method includes determining an availability of the key-box and determining an availability of digital tokens. Accordingly, the smart contract is executed for the first period of time by executing a first transaction and the executed first transaction and the executed smart contract are recorded in a block of a block chain. The includes receiving a request to extend the lease of the key-box for a second period of time, executing a second transaction, updating the smart contract and recording the updated smart contract and the executed second transaction in the block.

### FOREIGN PRIORITY

This application claims priority to Indian Patent Application No. 201911036398, filed Sep. 10, 2019, and all the benefits accruing therefrom under 35 U.S.C. § 119, the contents of which in its entirety are herein incorporated by reference.

### TECHNICAL FIELD OF INVENTION

The present invention generally relates to blockchain. More particularly, the invention relates to a system and a method for recording transactions in a blockchain.

### BACKGROUND OF THE INVENTION

Traditionally, a user could purchase or hire a key-box on rent/lease only in an offline mode. In other words, the user had to physically search and find a place to purchase or hire a key-box on lease. Further, there were limited method of making payment for buying a key-box or hiring a key-box on lease in an offline mode. With development in technology, advanced payment systems were introduced that enabled a user to make payment in an online mode for any purchase or lease. Using an internet service, a user can now easily make a payment in an online mode.

However, when a user hires or buys key-box on lease in an online mode, the user may not like the key-box when the key-box gets delivered. Further, the key-box delivered may be damaged or may have some faults. The user may also not return the key-box after expiry of a lease period. Moreover, when the user takes the key-box on lease in an online mode, the user may access some features of the key-box for which the user has not subscribed or else made a payment while taking the key-box on lease. For instance, the user may not pay additional payment for not returning the key-box on expiry of a lease period or for using the extra features of the key-box for which the user has not subscribed. Currently there is no solution to automatically receive additional payment from the user when the key-box is not returned on expiry of a lease period. Also, at present, there is no way to track the key-box which has been provided to the user on lease. Also, there does not exist any way to restrict a user for not using any extra feature/s of the key-box for which the user has not subscribed.

In view of the afore-mentioned problems in the existing solutions, there is a need of an efficient and effective system and a method for automatically executing transactions to order a key-box on lease. There is also a need to receive additional payment from a user when a key-box is not returned on expiry of a lease period. There is also a requirement for restricting a user for not using any extra feature/s of a key-box for which the user has not subscribed for. There is also a requirement for restricting activation and deactivation of a key-box by a user. In order to solve the problems in the existing solutions, a system and a method are disclosed.

### SUMMARY OF THE INVENTION

Various embodiments of the invention describe a method for recording transactions in a blockchain. The method comprises steps of creating a smart contract on receiving a request from a user to order a key-box on lease for a first period of time. The method further comprises steps of determining an availability of the key-box after receiving the request from the user and determining an availability of digital tokens in an account of the user based on the availability of the key-box. The method further comprises steps of executing the smart contract for the first period of time by executing a first transaction using the digital tokens and recording the first transaction and the executed smart contract in a block of a block chain to provide the key-box on lease. Moreover, the method further comprises steps of receiving a request from the user to extend the lease of the key-box for a second period of time and executing a second transaction to extend the lease of the key-box for the second period of time if the digital tokens are available in the account. The method also comprises steps of updating the smart contract to extend the lease of the key-box for the second period of time after executing the second transaction and recording the updated smart contract and the second transaction for the second period of time in the block of the blockchain.

In an embodiment of the invention, the block is appended to the blockchain after executing the first transaction.

In another embodiment of the invention, a request is received from the user to return the key-box when the key-box is damaged or when a delivered key-box is not ordered by the user. Digital tokens are remitted in the account after the key-box is returned. Further, the remittance of the digital tokens in the account is recorded in the block of the blockchain through the smart contract.

In yet another embodiment of the invention, a request is received from the user to activate the key-box and the key-box is activated for the user.

In still another embodiment of the invention, the smart contract is terminated when the key-box is returned. Further, the smart contract enables the user to access one or more features of the key-box subscribed by the user and restricts the user to access one or more features of the key-box not subscribed by the user.

In a different embodiment of the invention, the record of the first transaction or the second transaction in the blockchain is automatically deleted after an expiration of the second period of time or when the key-box is returned.

In another embodiment of the invention, the availability of the digital tokens in the account is determined when the key-box is available and the availability of the digital tokens in the account is not determined when the key-box is not available.

In yet another embodiment of the invention, the key-box is marked unavailable after the key-box is ordered by the user and the unavailability of the key-box is recorded in the block of the blockchain.

In another embodiment of the invention, the key-box is ordered or accessed by the user using an application on a user device.

In a different embodiment of the invention, the user device receives credentials from a server to access one or more features of the key-box subscribed by the user. Further, the server identifies the user device based on the credentials and provides access of one or more features of the key-box to the user.

In a different embodiment of the invention, a system is disclosed for recording transactions in a blockchain. The system comprises a receiver adapted to receive a request from a user to order a key-box on lease for a first period of time and a smart contract unit adapted to create a smart contract after the receiver receives the request from the user to order the key-box on lease. The system also comprises a determination unit adapted to determine an availability of the key-box after receiving the request from the user and determine an availability of digital tokens in an account of the user based on the availability of the key-box. The system further comprises an execution unit adapted to execute the smart contract for the first period of time by executing a first transaction using the digital tokens and recording the first transaction and the executed smart contract in a block of a block chain to provide the key-box on lease. Furthermore, the receiver is adapted to receive a request from the user to extend the lease of the key-box for a second period of time. Moreover, the execution unit is adapted to execute a second transaction to extend the lease of the key-box for the second period of time if the digital tokens are available in the account, update the smart contract to extend the lease of the key-box for the second period of time after executing the second transaction and recording the updated smart contract and the second transaction for the second period of time in the block of the blockchain.

In an embodiment of the invention, the receiver is adapted to receive a request from the user to return the key-box when the key-box is damaged or when a delivered key-box is not ordered by the user and the execution unit is adapted to remit the digital tokens in the account after the key-box is returned.

In another embodiment of the invention, the remittance of the digital tokens in the account is recorded in the block of the blockchain through the smart contract.

In yet another embodiment of the invention, the smart contract is terminated when the key-box is returned.

In still another embodiment of the invention, the record of the first transaction or the second transaction in the blockchain is automatically deleted after an expiration of the second period of time or when the key-box is returned.

In a different embodiment of the invention, the key-box is marked unavailable after the key-box is ordered by the user and the unavailability of the key-box is recorded in the block of the blockchain.

In another different embodiment of the invention, a computer readable medium is disclosed for recording transactions in a blockchain. The computer readable medium comprises one or more processors and a memory is coupled to the one or more processors, the memory storing instructions are executed by the one or more processors. The memory stores instructions executed by the one or more processors are configured to create a smart contract on receiving a request from a user to order a key-box on lease for a first period of time, determine an availability of the key-box after receiving the request from the user and determine an availability of digital tokens in an account of the user based on the availability of the key-box. The memory stores instructions executed by the one or more processors are further configured to execute the smart contract for the first period of time by executing a first transaction using the digital tokens and record the executed smart contract and the first transaction in a block of a blockchain to provide the key-box on lease. The memory stores instructions executed by the one or more processors are further configured to receive a request from the user to extend the lease of the key-box for a second period of time and execute a second transaction to extend the lease of the key-box for the second period of time if the digital tokens are available in the account. The memory stores instructions executed by the one or more processors are also configured to update the smart contract to extend the lease of the key-box for the second period of time after executing the second transaction and record the updated smart contract and the second transaction for the second period of time in the block of the blockchain.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1 depicts an exemplary system architecture according to an exemplary embodiment of the invention.

FIG. 2 depicts an exemplary blockchain having one or more blocks according to an exemplary embodiment of the invention.

FIG. 3 depicts block diagram of different components of a system according to an exemplary embodiment of the invention.

FIG. 4 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with a system and a method for executing and recording smart contract and transactions in a blockchain. When a user registers with a server/platform or places an order for a key-box on lease, a smart contract may be automatically created between the user and the server/platform. Such a smart contract may be executed when a transaction is made by the user. Further, the transaction may be executed when the user makes a payment (for the key-box) using digital tokens available in an account of the user. The executed smart contract and the executed transaction may be stored in a block of a blockchain.

As used herein, the transaction may be executed using digital tokens available in an account of the user when a user makes a payment to order the key-box on lease. Each executed transaction may be recorded in a block of a blockchain and such a block may then be appended in a blockchain. Such an account may be associated with an application using which the user orders the key-box.

As used herein, the digital tokens may be generated when a user transfers money from a bank account or a payment card of the user to the account associated with an application using which the user orders the key-box. Each money transferred to the account will be converted to the digital token or any computer wallet. For an example, 100 USD may be equivalent to 100 digital tokens.

As used herein, the smart contract may be a contract stored in a block of a blockchain. The smart contract binds two or more parties. In an embodiment of the invention the smart contract binds a user and a key-box provider, for example, when a transaction is executed to order a key-box on lease. Also, the smart contract may be executed when the transaction is executed using digital tokens. Further, the smart contract may be terminated when the user returns the key-box if the key-box is damaged, when a delivered key-box is not ordered by the user or on expiration of a lease period. When the smart contract is terminated, the corresponding record of the executed smart contract and the executed transaction stored in a block of the blockchain may also automatically get deleted from that block.

As used herein, the key-box may be a holder or container for holding/keeping key/s inside the key-box. Such a key-box can be ordered on lease by a user for a particular period of time. In an exemplary embodiment, the key-box may be a physical key-box or a digital key-box. The key-box may have a key container to hold physical keys physical access cards (RFID) using which a premises can be accessed by the user. Further, the key-box may be attached to a door of a premises. The premises may be a room, a home, a building or any such premises.

As used herein, the user may be an agent or a tenant or any such person who places an order to take the key-box on lease. The user may place the order for the key-box using an application stored in a user device.

As used herein, the server has processing capabilities as disclosed further in the specification. The server may be a cloud storage, a remote database, or any such storage known in the art.

As used herein, the user device may store one or more application in a memory of the user device. The user device may be a desktop computer or a hand held device such as a mobile phone or physical key device with/without a network connectivity. Example of the user device includes a desktop, workstation PC, a laptop, a smart phone, a tablet, a wearable device and the like.

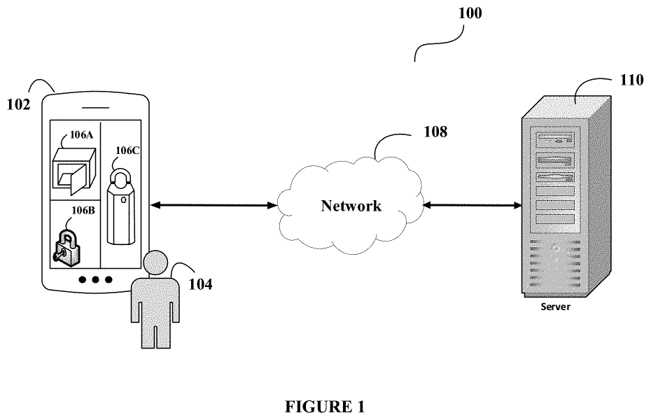

FIG. 1 depicts a system architecture 100 for executing and recording a smart contract and a transaction in a blockchain, according to an exemplary embodiment of the invention. As depicted in FIG. 1, a user device 102, a user 104 associated with the user device 102, a key-box 106A/106B/106C displayed on an interface of the user device 102, a server 110 connected to the user device 102 through a network 108.

In an exemplary embodiment of the present invention, when the user 104 registers with the server 110 through the network 108, a smart contract may be created by the server 110 between the user 104 and the server 110. In specific, the user 104 may register with the server 110 using an application stored in the user device 102. In an embodiment, the user 104 may register with the server 110 through the network 108 when the user 104 places a request to order the key-box 106A/106B/106C on lease using the application stored on the user device 102. Along with the request, the user 104 may also provide details (such as name, age, date of birth, an email id, country, shipping address, contact number, payment card details etc.) to the application. The application through the user device 102 may then transmit the registration request and the details of the user 104 to the server 110 using the network 108. Subsequently, the server 110 may create a smart contract between the user 104 and the server 110. In an alternative embodiment, the user 104 may register with the server when the user install an application on the user device 102 and registers with the application by providing details (such as name, age, date of birth, an email id, country, shipping address, contact number, payment card details etc.) to the application. The application through the user device 102 may then transmit such request and details of the user 104 to the server 110 through the network 108. Subsequently, the server 110 may create a smart contract between the user 104 and the server 110. When the server 110 creates the smart contract, the server 110 may store the smart contract in a block of a block chain. As used herein, the application may be provided by a manufacturer/developer of the key-box 106A/106B/106C, a service-provider of a key-box 106A/106B/106C, or may be any such application associated directly or indirectly with the key-box 106A/106B/106C.

Further, when the user 104 opens the application in an interface of the user device 102, the application may display the key-box 106A/106B/106C to the user 104. The user 104 may place a request to order the key-box 106A/106B/106C on lease for a first period of time. For this, the user may select the key-box 106A/106B/106C by clicking or tapping on the key-box 106A/106B/106C to order the key-box 106A/106B/106C on lease. Further, the user 104 may also specify/mention a first period of time (i.e. lease time) for which the user 104 wants to take the key-box 106A/106B/106C on lease. For an instance, the user 104 may specify “5 years” as a first period of time to take the key-box 106A/106B/106C on lease. Once the user 104 selects the key-box 106A/106B/106C and specify/mention the first period of time for lease, then the user 104 may send a request to the server 110 through the network 108.

The server 110 may determine an availability of the key-box 106A/106B/106C for the first period of time specified by the user 104. Determining an availability of the key-box 106A/106B/106C by the server 110 may comprise checking if any key-box106A/106B/106C is available which is not booked by any other user for the first period of time as specified by the user 104. In case the server 110 determines that the key-box 106A/106B/106C is not available for the period of time as specified by the user 104, then the server 110 may transmit a message to the user device 102 through the network 108 to inform the user 104 regarding the unavailability of the key-box 106A/106B/106C for the first period of time. Moreover, if the server 110 determines that the key-box 106A/106B/106C is available for the first period of time, the server 110 may determine an availability of digital tokens in an account of the user 104. Such an account may be associated with the application through which the user 104 places the request to order the key-box 106A/106B/106C on lease for the first period of time.

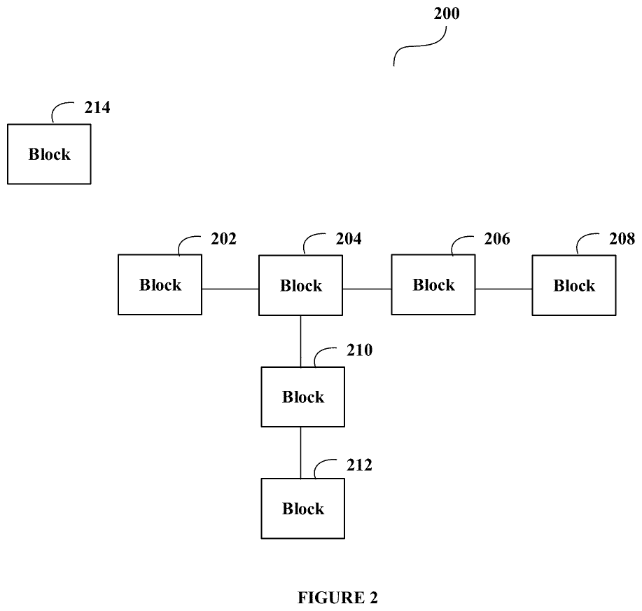

When the server 110 determines that digital tokens are not available in the account of the user 104, the server 110 may transmit an alert/notification to the user device 102 through the network 108 to inform the user 104 regarding the unavailability of the digital tokens in the account. When the user 104 receives such an alert/notification, the user 104 may add the digital tokens to the account by using a payment card. Further, when the server 110 determines that the digital tokens are available in the account of the user 104, the server 110 may execute a first transaction using the digital tokens available in the account to provide the key-box 106A/106B/106C on lease. By executing the first transaction, the server 110 may also execute the smart contract for the first period of time as specified by the user 104. Then, the server 110 may further record the executed first transaction and the executed smart contract (to provide the key-box 106A/106B/106C on lease for the first period of time) in a block of a blockchain. The recording of executed transactions and executed smart contract in a block of a blockchain are explained in greater details in FIG. 2.

After recording the executed first transaction and the executed smart contract in the block of the blockchain, the server 110 may transmit a message to the user device 102 through the network 108 confirming the user 104 to provide the key-box 106A/106B/106C on lease for the first period of time. After sending the confirmation to the user, the server 110 may mark the key-box 106A/106B/106C as unavailable for any other user and may also record the unavailability of the key-box 106A/106B/106C for the first period of time in the block of the block chain. In other words, the server 110 may mark the key-box 106A/106B/106C as unavailable till the expiration of the first period of time. Moreover, the server 110 may initiate a procedure to dispatch the key-box 106A/106B/106C to the user 104 in accordance with the details as provided by the user 104 to the server 110 at the time of registration as explained above. Further, the server 110 may terminate the executed smart contract between the user 104 and the server 110 on the expiration of the first period of time. For an instance, the executed smart contract may terminate on an expiration of 5 years (i.e. first period of time) from a date of placing the order to take the key-box 106A/106B/106C on lease. When the server 110 terminates the executed smart contract, the server 110 may automatically delete or remove the record of the executed smart contract and/or the first executed transaction from the block of the blockchain.

The present invention facilitates the user 104 to place a request to extend the lease of the key-box 106A/106B/106C by a second period of time before an expiration of the first period of time as specified by the user 104. For this, the user 104 may open the application on the interface of the user device 102 to display the order placed by the user 104 to take the key-box 106A/106B/106C on lease. Then, the user 104 may select an option to extend the lease of the key-box 106A/106B/106C and specifies/mentions a second period of time for extending the lease of the key-box 106A/106B/106C. For example, the user 104 may wish to extend the lease for next 2 years and specifies this as second period of time. After the user 104 specifies/mentions the second period of time, the user 104 may select to send the request for extending the lease of the key-box 106A/106B/106C to the server 110. Subsequently, the user device 102 may transmit the request for extending the lease of the key-box 106A/106B/106C for the second period of time to the server 110 through the network 108.

After receiving the request from the user 104, the server 110 may determine an availability of the key-box 106A/106B/106C for the second period of time as specified by the user 104. If the server 110 determines that the key-box 106A/106B/106C is available for the second period of time, then the server 110 may determine an availability of digital tokens in the account of the user 104. In case the server 110 determines that the key-box 106A/106B/106C is not available for the second period of time, the server 110 may transmit a message to the user device 102 through the network 108 to inform the user 104 regarding the unavailability of the key-box 106A/106B/106C for the second period of time.

When the server 110 determines that the digital tokens are available in the account of the user 104, the server 110 may execute a second transaction using the digital tokens available in the account to provide the key-box 106A/106B/106C on lease for the second period of time. And, the server 110 may also update the smart contract to extend the lease of the key-box 106A/106B/106C for the second period of time. Moreover, the server 110 may further record the executed second transaction and the updated smart contract (to provide the key-box 106A/106B/106C on lease for the second period of time) in the block of the blockchain. After recording the executed second transaction, the server 110 may transmit a message to the user device 102 through the network 108 confirming the user 104 to extend the lease of the key-box 106A/106B/106C for the second period of time. On extending the lease for the second period of time, the server 110 may mark the key-box 106A/106B/106C as unavailable during the second period of time for any other user and may also record the unavailability of the key-box 106A/106B/106C for the second period of time in the block of the block chain. Further, the server 110 may terminate the updated smart contract between the user 104 and the server 110 on the expiration of the second period of time. For an instance, the updated smart contract may terminate on an expiration of 2 years (i.e. second period of time) from a date of extending the lease of the key-box 106A/106B/106C or from the expiration of the 5 years (i.e. first period of time). On terminating the smart contract, the server 110 may automatically delete or remove the record of the updated smart contract and/or the second executed transaction from the block of the blockchain.

Once the user 104 receives the key-box 106A/106B/106C, the user 104 may initiate a request through the application to activate the key-box 106A/106B/106C. The user device 102 may transmit the request for activating the key-box 106A/106B/106C to the server 110 through the network 108. The server 110 may receive the request and may activate the key-box 106A/106B/106C for the user 104. The activation of the key-box 106A/106B/106C may comprise opening or accessing of the key-box 106A/106B/106C by the user 104. The present invention facilitates the server 110 to generate credentials for the user 104 to access the key-box 106A/106B/106C or to access one or more features of the key-box 106A/106B/106C when the user device 102 transmits the request for activating the key-box 106A/106B/106C. Then, the server 110 may transmit the credentials to the user device 102 through the network 108 for accessing the key-box 106A/106B/106C or accessing the one or more features of the key-box 106A/106B/106C. The user 104 may use the credentials to access the key-box 106A/106B/106C or access the one or more features of the key-box 106A/106B/106C. The user 104 is identified based on the credentials for providing access of the key-box 106A/106B/106C or the one or more features of the key-box 106A/106B/106C to the user 104. Such credentials may be a password, a personal identification number (PIN) or any such credentials well known in the art. In addition, the server 110 may record the credentials in a block of a blockchain.

The present invention further facilitates the user 104 to subscribe for the one or more features associated with the key-box 106A/106B/106C through a smart contract. The user 104 may subscribe for the one or more features associated with the key-box 106A/106B/106C at the time when the user 104 places a request to order the key-box 106A/106B/106C for a first period of time or a second period of time as explained above. The smart contract along the subscription of the one or more features associated with the key-box 106A/106B/106C may be stored and recorded in a block of the block chain. As a result, the smart contract may enable the user 104 to access the one or more features of the key-box 106A/106B/106C which are subscribed by the user 104. Further, the smart contract may also restrict the user 104 to access the one or more features of the key-box 106A/106B/106C that are not subscribed by the user 104. As used herein, the one or more features may be opening or closing of a key-box through an application, opening or closing of a key-box through a key, sharing audits (i.e. opening or closing of a key-box) with any user, sharing location of the key-box with any user, releasing a shackle of a key-box, opening of a key-box compartment, programing the key-box, showing day and date on the key-box, showing listings, providing tour of a premises, or any such feature that is obvious to a person skilled in the art.

After an expiration of the first period of time or the second period of time or when key-box 106A/106B/106C is moved away from a network from ‘n’ number days, then a status associated with the key-box 106A/106B/106C may be changed to Inactive status. The inactive status of the key-box 106A/106B/106C may be recorded in the Block 214 and then, the server may transmit a notification to the user 104. Such notification may inform the user 104 about the inactive status of the key-box 106A/106B/106C and that the user 104 may activate the key-box 106A/106B/106C again by making a call to a provider of the key-box 106A/106B/106C.

The present invention further facilitates the user 104 to initiate a request for returning the key-box 106A/106B/106C if the key-box 106A/106B/106C is damaged. The user 104 may also return a delivered key-box when the delivered key-box is not the one or same that is ordered by the user 104. The user 104 may initiate such a return request using the application after the key-box 106A/106B/106C is delivered to the user 104. The user device 102 may transmit the request for returning the key-box 106A/106B/106C to the server 110 through the network 108. The server may start a procedure for returning the key-box 106A/106B/106C. Once the user 104 returns the key-box 106A/106B/106C, the server 110 may remit the digital tokens in the account of the user 104. The server 110 may record the remittance of the digital tokens to the user 104 in a block of a block chain. Also, the server 110 may terminate the smart contract between the user 104 and the server 110 after the remittance of the digital tokens to the user 104.

FIG. 2 depicts an exemplary block chain 200 having one or more blocks, according to an exemplary embodiment of the invention. As depicted in FIG. 2, the exemplary blockchain 200 may have six exemplary blocks namely block 202 to block 214. In particular, Block 202 may be connected with Block 204, Block 204 may be connected with Block 206 and Block 210, Block 210 may be connected Block 212, and Block 206 may be connected with Block 208. Each of these blocks 202-214 may record/s each transaction executed using digital tokens and a smart contract executed after executing the transaction. Also, each of these blocks 202-214 may record transaction and smart contract executed by other users. Each of these blocks 202-214 may be secured and protected using any well-known cryptographic hash function. In specific, the cryptographic hash function calculates a hash value for each block 202-214 after any record is added or deleted from the block 202-214. The hash value maintains integrity of data recorded by each block 202-214 and thus avoids any conflict or unauthorized changes made in the data recorded by each block 202-214. Further, the server 110 may create and assign a public key and a private key to each user for executing any transaction and a smart contract in a block of the blockchain 200.

Considering an example, when a user 104 registers with a server 110 as explained above in FIG. 1, a smart contract is created between the user 104 and the server 110 which is recorded in the block 214. Moreover, when a first transaction is executed using the digital tokens available in an account of the user 104, the server 110 may also record the executed first transaction in the block 214. Along with this, when the server 110 executes the smart contract for a first period of time as specified by the user 104, the server 110 may further record the executed smart contract in the block 214. The executed smart contract recorded in the block 214 may include all the details (discussed in FIG. 1 above) as specified by the user 104. In one embodiment, the server 110 may append the block 214 to the block chain 200 after recording the executed transaction or after recording the executed smart contract. Then, the server may transmit the executed smart contract to the user device 02. In an alternative embodiment, the server 110 may append the block 214 to the block chain 200 after creating the smart contract. Specifically, the server 110 may append the block 214 to the block 208 or to the block 212 depending upon the nature of the executed smart contract and the executed first transaction. The block 214 may also store and record details like name, age, date of birth, an email id, country, shipping address, contact number, payment card details of the user 104, lease period of time to take the key-box 106A/106B/106C on lease, a number of key-box and one or more features subscribed by the user 104 etc.

When the server 110 receives a request from the user 104 for extending the lease of the key-box 106A/106B/106C for a second period of time, the server 110 may record a second transaction in the appended block 214 if the second transaction is executed using the digital tokens available in the account to provide the key-box 106A/106B/106C on lease for the second period of time. Also, the server 110 may update the executed smart contract recorded in the block 214 to extend the lease of the key-box 106A/106B/106C for the second period of time. Furthermore, the block 214 in the server 110 may also record one or more features associated with the key-box 106A/106B/106C as subscribed by the user 104 through the smart contract.

When the server 110 receives a request from the user 104 for returning the key-box 106A/106B/106C, the server 110 may record remittance of the digital tokens to the user 104 in the block 214. Moreover, the server 110 terminates the smart contract of the user 104 after the user 104 returns the key-box 106A/106B/106C or after an expiration of the first period of time or the second period of time. The server 110 may automatically delete or remove the record of the executed smart contract, the executed first transaction and/or the executed second transaction 106C from the block 214. In addition, the server 110 may automatically delete or remove the record of credentials provided to the user 104 for accessing the key-box 106A/106B/106C or one or more features of the key-box 106A/106B/106C.

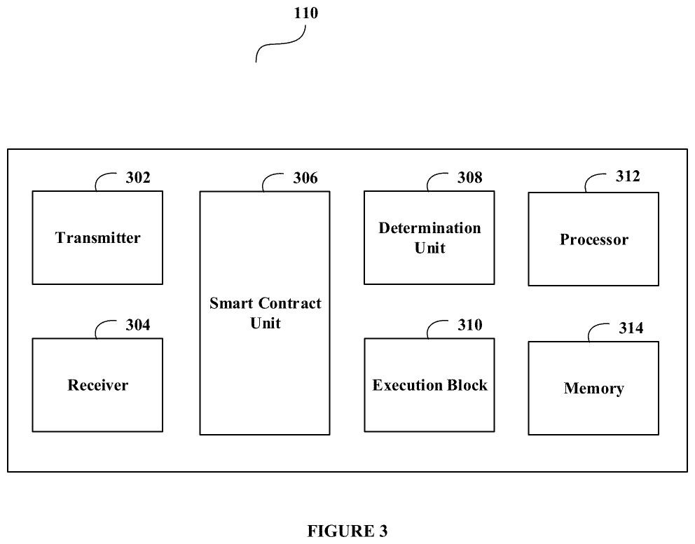

FIG. 3 depicts a block diagram of different components of a server 110 according to an exemplary embodiment of the invention. The server 110 may comprise of, but is not limited to, a transmitter 302, a receiver 304, a smart contract unit 306, and a determination unit 308, an execution unit 310, a processor 312 and a memory 314. The receiver 304 may be adapted to receive a request along with details from a user 104 to order a key-box 106A/106B/106C on lease for a first period of time. The receiver 304 may also be adapted to receive a request from the user 104 to extend the lease of the key-box 106A/106B/106C for a second period of time. The receiver 304 may further be adapted to receive a request from the user 104 to activate the key-box 106A/106B/106C and/or to return the key-box 106A/106B/106C. The receiver 304 may also be adapted to communicate the request received from the user 104 to the smart contract unit 306. The smart contract unit 306 may be adapted to create a smart contract between the server 110 and the user 104 after the receiver communicates the request of the user 104 to order the key-box 106A/106B/106C on lease. After the smart contract unit 306 creates the smart contract, the determination unit 308 may be adapted to determine an availability of the key-box 106A/106B/106C for the first period of time and/or the second period of time as specified by the user 104. The determination unit 306 may also be adapted to determine availability of digital tokens in an account of the user 104 if the key-box 106A/106B/106C is available to lease for the first period of time and/or the second period of time. Also, the determination unit 306 may also be adapted to communicate the availability of digital tokens to the execution unit 308.

The execution unit 308 may be adapted to execute a first transaction using the digital tokens in the account to provide the key-box 106A/106B/106C on lease for the first period of time. The execution unit 308 may also be adapted to execute a smart contract for the first period of time as specified by the user 104 by executing the first transaction. The execution unit 308 may be adapted to execute a second transaction using the digital tokens in the account to extend the lease for the second period of time. The execution unit 308 may also be adapted to update the smart contract for the second period of time. The execution unit 308 may further be adapted to record the executed smart contract, record the executed first transaction, record the updated smart contract, record the executed second transaction, record the unavailability of the key-box 106A/106B/106C for the first/second period of time, remit the digital tokens to the account of the user 104 and/or record the remittance of the digital tokens. The execution unit 308 may be in communication with the transmitter 302 to communicate an alert/notification to inform the user 104 regarding the unavailability of the digital tokens, a message to inform the user 104 regarding unavailability of the key-box 106A/106B/106C for the first/second period of time or a confirmation for providing the key-box 106A/106B/106C to the user 104 for the first/second period of time. The transmitter 302 may be adapted to transmit the alert/notification, the message and/or the confirmation to the user device 102 of the user 104 through the network 108. Moreover, the transmitter 302, the receiver 304, the smart contract unit 306, the determination unit 308, the execution unit 310 and/or the memory 314 may be communicably coupled with the processor 312. The different units described herein are exemplary. The invention may be performed using one or more units. For example, the tasks executed by the transmitter 302, the receiver 304, the smart contract unit 306, the determination unit 308, the execution unit 310 may be performed by a single unit. Alternatively more number of units as described herein may be used to perform the invention.

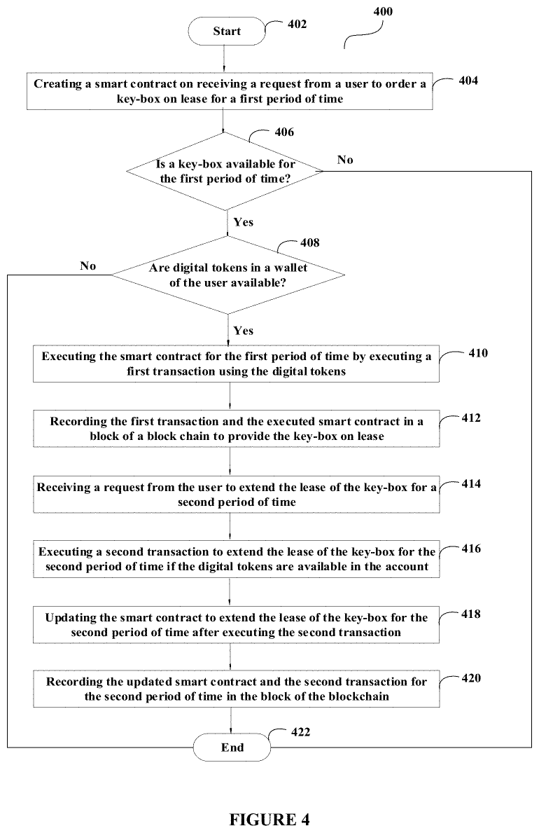

FIG. 4 depicts a flowchart outlining the features of the invention in an exemplary embodiment of the invention. The method flowchart 400 describes a method being performed for executing and recording transactions in a blockchain. The method flowchart 400 starts at step 402.

At step 404, the server 110 may create a smart contract when the server 110 receives a request from a user 104 to order a key-box 106A/106B/106C on lease for a first period of time.

At step 406, the server 110 may determine an availability of the key-box 106A/106B/106C for the first period of time as specified by the user 104. Determining an availability of the key-box 106A/106B/106C by the server 110 may involve checking if any key-box 106A/106B/106C is available which is not booked by any other user for the first period of time as specified by the user 104. In case the server 110 determines that the key-box 106A/106B/106C is not available for the period of time as specified by the user 104, then the method 400 may end at step 422. Moreover, if the server 110 determines that the key-box 106A/106B/106C is available for the first period of time as specified by the user 104, then the method 400 may move to step 408.

At step 408, the server 110 may determine an availability of digital tokens in an account of the user 104 to take the key-box 106A/106B/106C on lease for the first period of time. When the server 110 determines that digital tokens are not available in the account of the user 104, then the method 400 may end at step 422. The server 110 may transmit an alert/notification to the user device 102 through the network 108 to inform the user 104 regarding the unavailability of the digital tokens in the account. Further, when the server 110 determines that the digital tokens are available in the account of the user 104, then the method 400 may move to step 410.

At step 410, the server 110 may execute the smart contract for the first period of time as specified by the user 104 by executing a first transaction using the digital tokens available in the account.

At step 412, the server 110 may record the executed first transaction and the executed smart contract (to provide the key-box 106A/106B/106C on lease for the first period of time as specified by the user 104) in a block of a blockchain as explained in FIG. 2 above. After recording the executed first transaction and the executed smart contract in the block of the blockchain, the server 110 may transmit a message to the user device 102 through the network 108 for confirming the user 104 to provide the key-box 106A/106B/106C on lease for the first period of time.

At step 414, the server 110 may receive a request from the user 104 for extending the lease of the key-box 106A/106B/106C for the second period of time. Based on the request, the server 110 may determine an availability of the key-box 106A/106B/106C for the second period of time as specified by the user 104. If the server 110 determines that the key-box 106A/106B/106C is available for the second period of time, then the server 110 may also determine an availability of digital tokens in the account of the user 104. In case the server 110 determines that the key-box 106A/106B/106C is not available for the second period of time as specified by the user 104, then the server 110 may transmit a message to the user device 102 through the network 108 to inform the user 104 regarding the unavailability of the key-box 106A/106B/106C for the second period of time.

At step 416, the server 110 may execute a second transaction using the digital tokens in the account to provide the key-box 106A/106B/106C on lease for the second period of time if the server 110 determines that the digital tokens are available in the account of the user 104.

At step 418, the server 110 may update the smart contract to extend the lease of the key-box 106A/106B/106C for the second period of time after executing the second transaction.

At step 420, the server 110 may record the executed second transaction and the updated smart contract (to provide the key-box 106A/106B/106C on lease for the second period of time) in the block of the blockchain. After recording the executed second transaction and the updated smart contract in the block of the blockchain, the server 110 may transmit a message to the user device 102 through the network 108 for confirming the user 104 to extend the lease of the key-box 106A/106B/106C for the second period of time. The method flowchart may end at 422.

The present invention is applicable to various fields/industries such as, but is not limited to, real-estate industry, hospitality industry, banking industry, hostels, educational institutes, homes, offices, and any such field/industry where the key-box can be used and is obvious to a person skilled in the art.

The present invention provides the following technical advantages over the existing solutions a) automatically creates, maintains and deletes records in a block of block chain, b) binds user and a service provider through a smart contract for using a key-box, c) restricts or provides access of one or more features of the key-box to the user based on user's subscription, d) automatically deducts digital tokens from an account of the user if the key-box is not returned by the user after an expiration of lease period time, and e) automatically records the executed transactions and the executed smart contract in a block of a block chain, and f) automatically records the updated smart contract in a block of a block chain.

The embodiments of the invention and the tables discussed herein are exemplary and various modification and alterations to a person skilled in the art are within the scope of the invention.

In one embodiment of the invention, the invention can be operated using the one or more computer readable devices. The one or more computer readable devices can be associated with a server 110. A computer readable medium comprises one or more processors and a memory coupled to the one or more processors, the memory stores instructions which are executed by the one or more processors, the one or more processors configured to create a smart contract on receiving a request from a user 104 to order a key-box 106A/106B/106C on lease for a first period of time. The memory stores instructions that are executed by the one or more processors, the one or more processors configured to determine an availability of the key-box after receiving the request from the user 104 and determine an availability of digital tokens in an account of the user 104 based on the availability of the key-box 106A/106B/106C. The memory stores instructions that are executed by the one or more processors, the one or more processors also configured to execute the smart contract for the first period of time by executing a first transaction using the digital tokens and record the executed smart contract and the first transaction in a block of a blockchain to provide the key-box 106A/106B/106C on lease. The memory stores instructions which are executed by the one or more processors, the one or more processors configured to receive a request from the user 104 to extend the lease of the key-box 106A/106B/106C for a second period of time and execute a second transaction to extend the lease of the key-box 106A/106B/106C for the second period of time if the digital tokens are available in the account. The memory stores instructions that are executed by the one or more processors, the one or more processors further configured to update the smart contract to extend the lease of the key-box 106A/106B/106C for the second period of time after executing the second transaction and record the updated smart contract and the second transaction for the second period of time in the block of the blockchain.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Furthermore, the terms “user,” “subscriber,” “customer,” “consumer,” “agent,” and the like are employed interchangeably throughout the subject specification, unless context warrants particular distinction(s) among the terms. Such terms can refer to human entities or automated components supported through artificial intelligence (e.g., a capacity to make inference based on complex mathematical formalisms) which can provide simulated vision, sound recognition and so forth.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
creating a smart contract on receiving a request from a user to order a key-box on lease for a first period of time;
determining an availability of the key-box after receiving the request from the user;
determining an availability of digital tokens in an account of the user based on the availability of the key-box;
executing the smart contract for the first period of time by executing a first transaction using the digital tokens;
recording the first transaction and the executed smart contract in a block of a block chain to provide the key-box on lease;
receiving a request from the user to extend the lease of the key-box for a second period of time;
executing a second transaction to extend the lease of the key-box for the second period of time if the digital tokens are available in the account;
updating the smart contract to extend the lease of the key-box for the second period of time after executing the second transaction; and
recording the updated smart contract and the second transaction for the second period of time in the block of the blockchain.

2. The method of claim 1, wherein the block is appended to the blockchain after executing the first transaction.

3. The method of claim 1, further comprising, receiving a request from the user to return the key-box when the key-box is damaged or when a delivered key-box is not ordered by the user and remitting digital tokens in the account after the key-box is returned.

4. The method of claim 3, wherein the remittance of the digital tokens in the account is recorded in the block of the blockchain through the smart contract.

5. The method of claim 1, further comprising, receiving a request from the user to activate the key-box and activating the key-box for the user.

6. The method of claim 1, wherein the smart contract is terminated when the key-box is returned.

7. The method of claim 1, wherein the smart contract enables the user to access one or more features of the key-box subscribed by the user and restricts the user to access one or more features of the key-box not subscribed by the user.

8. The method of claim 1, wherein the record of the first transaction or the second transaction in the blockchain is automatically deleted after an expiration of the second period of time or when the key-box is returned.

9. The method of claim 1, wherein the availability of the digital tokens in the account is determined when the key-box is available and the availability of the digital tokens in the account is not determined when the key-box is not available.

10. The method of claim 1, wherein the key-box is marked unavailable after the key-box is ordered by the user and the unavailability of the key-box is recorded in the block of the blockchain.

11. The method of claim 1, wherein the key-box is ordered or accessed by the user using an application on a user device.

12. The method of claim 11, wherein the user device receives credentials from a server to access one or more features of the key-box subscribed by the user.

13. The method of claim 12, wherein the server identifies the user device based on the credentials and provides access of one or more features of the key-box to the user.

14. A system comprising:
a receiver adapted to receive a request from a user to order a key-box on lease for a first period of time;
a smart contract unit adapted to create a smart contract after the receiver receives the request from the user to order the key-box on lease;
a determination unit adapted to:
determine an availability of the key-box after receiving the request from the user; and
determine an availability of digital tokens in an account of the user based on the availability of the key-box;
an execution unit adapted to:
execute the smart contract for the first period of time by executing a first transaction using the digital tokens; and
recording the first transaction and the executed smart contract in a block of a block chain to provide the key-box on lease;
the receiver adapted to receive a request from the user to extend the lease of the key-box for a second period of time; and
the execution unit adapted to:
execute a second transaction to extend the lease of the key-box for the second period of time if the digital tokens are available in the account;
update the smart contract to extend the lease of the key-box for the second period of time after executing the second transaction; and
recording the updated smart contract and the second transaction for the second period of time in the block of the blockchain.

15. The system of claim 14, wherein the receiver is adapted to receive a request from the user to return the key-box when the key-box is damaged or when a delivered key-box is not ordered by the user and the execution unit is adapted to remit the digital tokens in the account after the key-box is returned.

16. The system of claim 14, wherein the remittance of the digital tokens in the account is recorded in the block of the blockchain through the smart contract.

17. The system of claim 14, wherein the smart contract is terminated when the key-box is returned.

18. The system of claim 14, wherein the record of the first transaction or the second transaction in the blockchain is automatically deleted after an expiration of the second period of time or when the key-box is returned.

19. The system of claim 14, wherein the key-box is marked unavailable after the key-box is ordered by the user and the unavailability of the key-box is recorded in the block of the blockchain.

20. A computer readable medium comprising one or more processors and a memory coupled to the one or more processors, the memory storing instructions being executed by the one or more processors, the one or more processors configured to:
create a smart contract on receiving a request from a user to order a key-box on lease for a first period of time;
determine an availability of the key-box after receiving the request from the user;
determine an availability of digital tokens in an account of the user based on the availability of the key-box;
execute the smart contract for the first period of time by executing a first transaction using the digital tokens;
record the executed smart contract and the first transaction in a block of a blockchain to provide the key-box on lease;
receive a request from the user to extend the lease of the key-box for a second period of time;
execute a second transaction to extend the lease of the key-box for the second period of time if the digital tokens are available in the account;
update the smart contract to extend the lease of the key-box for the second period of time after executing the second transaction; and
record the updated smart contract and the second transaction for the second period of time in the block of the blockchain.
